(19) United States
(12) Patent Application Publication
(10) Pub. No.: US 2023/0194170 A1
(43) Pub. Date: Jun. 22, 2023

(54) LOW-ENERGY DRYING SYSTEM AND METHOD

(71) Applicant: PHINITE INC, Raleigh, NC (US)

(72) Inventor: Jordan Phasey, Durham, NC (US)

(21) Appl. No.: 18/085,234

(22) Filed: Dec. 20, 2022

Related U.S. Application Data
(60) Provisional application No. 63/291,907, filed on Dec. 20, 2021.

(51) Int. Cl. F26B 9/10; F26B 25/00

(52) U.S. Cl. CPC F26B 9/10; F26B 25/001; F26B 2200/18

(57) ABSTRACT

A low-energy drying system and method including a drying bed having at least four edges for holding the material to be dried, walls connected to the edges of the drying bed, a cover encompassing the drying bed and the wall, the cover having air permeable side walls, and air flow directors for directing air over the material in the drying bed.

### CROSS-REFERENCE TO RELATED APPLICATIONS

This application claims the benefit of U.S. Provisional Application No. 63/291,907, filed on Dec. 20, 2021. The entire disclosure of the above application is incorporated herein by reference.

### FIELD

The present technology relates to a low-energy drying system. More specifically, the present technology relates to a system for low-energy drying sludge.

### INTRODUCTION

This section provides background information related to the present disclosure which is not necessarily prior art.

The storage, handling and effective utilization of animal waste is an ongoing challenge for animal agricultural industries, particularly in concentrated animal feeding operations (CAPOs). The swine and poultry industries, for example, produce a significant amount of animal waste that must be properly handled and utilized to ensure profitability and environmental sustainability. Such efforts are important, particularly where CAFOs are prevalent in large numbers in states such as North Carolina and Iowa.

Legislative efforts, both federally and at the state level, set forth environmental regulations as well as incentives to develop alternative and productive uses for animal waste. Incentives are in place to effectively utilize animal waste as an energy source in North Carolina.

For example, the Renewable Energy and Energy Efficiency Portfolio Standard (REPS) previously required that North Carolina power companies provide approximately 30 MW of electrical capacity from swine waste by 2021. The fuel source for this power was originally foreseen to be methane from anaerobically digested pig manure. However, North Carolina power producers struggled to meet this target, which has since been removed, and are currently producing a fraction of the required amount. Clearly the anaerobic pathway to energy production is insufficient to produce this target give current incentives.

Moreover, regulations require that nutrients within animal waste must be utilized properly to minimize potential negative environmental impacts. For example, application of animal waste to land must be carefully controlled and monitored to avoid pollution.

The moisture content of these waste products presents a significant challenge to their efficient utilization. Water adds significant bulk and weight to this material, for example a manure with a solids content of 10% w/w contains 90% moisture. This moisture means the material weighs 9X more than it would if it were dry, with consequential challenges handling and transporting this significant extra weight. Moreover the handling properties of these material are a challenge, as they typically do not behave as a solid; so different handling approaches are needed. Clearly, removing moisture through the use of drying technology is advantageous to the efficient utilization of these waste products.

Many conventional drying technologies exist, however most conventional dryers used in industry require fossil fuels to provide the necessary energy and are thus large energy consumers within industry. Typically, the cost and complexity of using conventional “fueled” waste dryers has limited the adoption of these technologies within the manure drying space.

Achieving a dry waste product, particularly agricultural waste product is easier in dry climates where a significant moisture deficit exists, cost-effective sludge drying can be achieved using conventional technology such as sludge drying beds or sludge drying lagoons. However, in humid climates, particularly those where there is an annual moisture surplus, such simple drying systems may not be employed. Many customers are present in such climates, thus, there is a substantial need for cost-effective drying systems in these climates.

Currently, the use of solar energy to dry sludge has been commonly utilized. A typical solar sludge dryer includes a solar heat collector, and the solar heat collector is required to have adequate insulation properties to ensure appropriate energy efficiency. In practice, solar sludge dryers are typically made of glass, thus are expensive to construct. Designs using hoop greenhouses exist, however the poorer insulation properties and inefficiencies of the design yield a lower areal drying rate relative to those made of glass, requiring more space and expense to construct and handle the drying load.

Accordingly, there remains a significant need for alternative pathways and approaches to effectively manage and utilize animal waste, including converting animal waste into usable energy or other marketable products such as fertilizer.

### SUMMARY

In concordance with the instant disclosure, alternative pathways and approaches to effectively manage and utilize animal waste, including converting animal waste into valuable products energy are surprisingly discovered. Disclosed herein are novel systems, devices and methods to address the ongoing need to effectively utilize swine waste (and other animal waste) for other purposes, thereby addressing address these long-felt needs.

In one embodiment, a method of drying a material, comprises performing at least one of: depositing a material to be dried in a material drying system; mixing the material within the material drying system to a self-supporting state; configuring the material to maximize a surface area of the material in contact with an ambient air; drying at least a portion of the material contained in the material drying system to a selected target percentage of solids content, wherein a relative humidity deficit of the ambient air is utilized to dry the material; and removing at least a portion of the dried material from the material drying system.

In another embodiment, a method of drying a material, comprises providing a material drying system, the material drying system including a drying bed for holding a material to be dried, the drying bed having a base; a cover placed over the drying bed and configured to substantially prevent a second material from falling on the material held in the drying bed and permit a flow of an ambient air through the material drying system; a handling tool disposed adjacent the drying bed, the handling tool configured to mix the material and maximize a surface area of the material that is in contact with the ambient air flowing through the material drying system; and a fan disposed adjacent at least one of the drying bed and the cover, the fan configured to facilitate the flow of the ambient air through the material drying system; and performing at least one of depositing a material to be dried in a material drying system; mixing the material within the material drying system to a self-supporting state; configuring the material to maximize a surface area of the material in contact with the ambient air; drying at least a portion of the material contained in the material drying system to a selected target percentage of solids content, wherein a relative humidity deficit of the ambient air is utilized to dry the material; and removing at least a portion of the dried material from the material drying system.

In yet another embodiment, A material drying system comprises a drying bed for holding a material to be dried, the drying bed having a base; a cover placed over the drying bed and configured to substantially prevent a second material from falling on the material held in the drying bed and permit a flow of an ambient air through the material drying system; a handling tool disposed adjacent the drying bed, the handling tool configured to mix the material and maximize a surface area of the material that is in contact with the ambient air flowing through the material drying system; and a fan disposed adjacent at least one of the drying bed and the cover, the fan configured to facilitate the flow of the ambient air through the material drying system.

In another embodiment, a low-energy drying system and method includes a drying bed having at least four edges for holding the material to be dried, walls connected to the edges of the drying bed, a cover encompassing the drying bed and the wall, the cover having air permeable side walls, and air flow directors for directing air over the material in the drying bed.

The present technology includes articles of manufacture, systems, and processes that relate to an a low-energy drying system.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is perspective view of a material drying system according to an embodiment of the present disclosure;

FIG. 2 is a fragmentary perspective view of the material drying system of FIG. 1 showing a material held in a drying bed of the material drying system and a mixer for mixing the material held in the drying bed of the material drying system;

FIG. 3 is a fragmentary perspective view of the material drying system of FIG. 1 showing the material held in the drying bed of the drying system arranged in rows;

FIG. 4 is cross-sectional elevational view of a material drying system according to an embodiment of the present disclosure;

FIG. 5 is a fragmentary top perspective view of a material drying system according to an embodiment of the present disclosure showing an air flow director, an air flow collection device and a fan to facilitate the flow of air flow through the material drying system;

FIGS. 6-7 are cross-sectional elevational views of the rows of the material of FIG. 3 showing a cross-sectional shape of the row of the material according to embodiments of the present disclosure;

FIG. 8 is a cross-sectional elevational view of the row of the material of FIG. 3 showing a surface texture of the row of material according to an embodiment of the present disclosure;

FIG. 9 is a cross-sectional elevational view of the row of the material of FIG. 3 showing a porous configuration of the row of material according to an embodiment of the present disclosure;

FIG. 10 is a cross-sectional end view of a material drying system according to an embodiment of the present disclosure;

FIG. 11 is a cross-sectional end view of a material drying system according to an embodiment of the present disclosure;

FIG. 12 is a schematic illustration of a control system for a material drying system, according to an embodiment of the present disclosure, showing the interaction between a controller, sensors, conditions and functioning components of the material drying system; and

FIG. 13 is a flowchart illustrating a method of using a material drying system.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps may be different in various embodiments, including where certain steps may be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically may include embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature’s relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

The term “drying” as used herein references the evaporation of water from solid material. Typically, the removal of water from solids can be characterized as either dewatering or drying. The removal of free water (typically from <1% solids up to 20-30%) from solids is generally referred to as dewatering. Dewatering can remove the water that is present in the interstitial space between solid particles. During dewatering the water can be removed using physical methods including gravity drainage, filtration, and centrifugation. Drying is the removal of water that is adsorbed to solid particles (typically the water remaining after dewatering, where the material is typically 20-30% solids, 70-80% moisture by weight). This water typically cannot be removed by physical (mechanical) means, and instead is typically removed by evaporation of the liquid. The evaporation of water is typically a very energy intensive process whereby the latent heat of vaporization of water is approximately 2,260 kJ/kg.

The present invention relates to a system and method for drying a material, such as a sludge, for example. It should be understood that the material to be dried can also be products produced by various processes, including, but not limited to, power generation, mining, industrial, water and wastewater treatment, and agricultural products.

The energy intensity of drying processes presents a significant challenge to their use in economically recovering and concentrating waste materials, particularly in cases where the moisture content of the waste product is significant. In some cases, a low-cost energy source may be found, such as waste heat from an industrial process, and this may yield an economical drying process. But in most cases, such an energy source is not available. There remains a clear need for drying technology where the energy used for drying does not need to be paid for. In the case of sludge drying, an established technology exists - solar sludge drying. However, the high cost of this technology (despite lower energy costs) has still prevented its widespread adoption in the recovery of valuable waste materials.

Drying using ambient air is well known, particularly in the drying of agricultural products. Examples include drying of hay in a field, sun drying of produce (tomatoes, chillis etc.) or natural air drying of grain within a grain bin. Drying using ambient air is simple to do in dry climates but is more challenging in humid climates where rainfall may impact the drying process and where the moisture deficit is lower (and therefore less useful) than in dry climates. Despite this, we have surprisingly determined that in humid climates, there can be still a useful moisture deficit that exists in the ambient air. This deficit can be thought of as surplus energy that can be available for drying. The deficit can be used to calculate the difference between the relative humidity of the air and the critical relative humidity of the material being dried. Once the deficit can be quantified, the amount of surplus energy available can be calculated.

Consider a typical 36″ propellor fan with an airflow capacity of 11,000 CFM and a power consumption of 500 W. According to the typical RH deficit in NC, such a fan can be capable of moving air with 19-32 kW of energy in it every hour, while consuming 0.5 kWh of energy. This can be a force multiplier of 38-64 relative to the electricity consumption of the fan. This force multiplier is substantial and may be used to form the basis of a drying system designed to exploit this energy.

In another example, you can calculate the available energy that can be harnessed from the air at normal wind speeds. For example, an open area has typically has a significant quantity of air blowing past it at any given moment owing to the prevailing winds. This air has the same relative humidity deficit as described above, and as a result, a significant amount of energy may be captured within a structure available for use in drying. Using appropriate ventilation techniques such as a long, narrow drying system, positioned perpendicular to the wind, it can be possible to capture this energy for use in drying sludge. For an appropriately long and narrow structure, we have surprisingly determined that this energy source can be substantially larger than the solar radiation shining upon the structure (which is the principal energy source used by a solar dryer). Consequently, the drying system has at its disposal a larger amount of energy available for drying. If the design is optimized appropriately, faster drying rates may be achieved than would be present using a conventional solar sludge dryer.

In order to achieve this outcome however, a number of additional factors are also required. Airflow and material arrangement must be designed in a way to maximize the amount of mixing of air with material, to prevent the formation of a humid boundary layer on the material, and the surface area of the material must be enhanced. It can be the combination of the harnessing of the energy present within ambient air with enhancement of the material’s surface area that provides the enhanced areal drying rate relative to conventional solar drying.

In a solar sludge dryer, the structure of the system exists to provide an insulated environment for solar energy capture. This is often expensive to construct and adds significantly to the cost of drying. In the present disclosure, the cover of the system exists only to exclude rainwater, and sometimes assist in directing airflow. Therefore, a lower cost structure can be used for the structure, further providing a more cost-effective system than can be found in a conventional solar sludge dryer.

The amount of drying that occurs per unit area (for example, lbs of moisture loss per square foot of structure area) is known as the areal drying rate. Sizing of drying systems can be determined based on the amount of drying load required. The average areal drying rate that can be achieved by a system can be considered a reasonable approximation for system sizing. Solar sludge drying systems are intrinsically coupled to the amount of solar energy available for drying. Such solar drying systems that do not utilize additional energy (such as waste heat) can be considered to be energy limited, because enhancing the drying capacity of the unit can only be done by increasing the site footprint. There can be relatively little advantage to optimizing performance within the unit (except to push the drying rate towards 100% solar energy utilization).

In contrast, the system of the present disclosure can enable substantially higher areal drying rates using ambient air drying than with other conventional solar sludge drying. This yields consequently smaller site footprints and consequently lower cost of construction.

The system of the present disclosure can provide two fundamental advantages. First, a design that can exploit the moisture deficit of ambient air to achieve higher drying performance than the current state of the art. Second, the system can achieve this outcome using less expensive materials, thus yielding consequently lower capital cost to construct. Even attaining a drying rate that can be equivalent to the current state-of-the-art systems, but at lower cost, would be considered useful and an improvement on the existing devices and systems.

The material drying system of the present disclosure can take advantage of the moisture deficit in ambient air which can provide significant advantages for drying relative to conventional drying. The energy utilized for drying the material is principally derived from the relative humidity deficit that exists in ambient air. This is specifically different from solar energy that is collected by other devices and used for evaporation, such as a solar sludge dryer. This energy from the relative energy deficit may be leveraged by maximizing the quantity of ambient air exchange and/or harvesting that takes place within the material drying device, wherein the quantity of outside air can add considerably to the overall energy available for drying the material within the material drying system. Furthermore, natural ventilation, such as atmospheric wind, for example, can further facilitate utilizing sufficiently high quantities of ambient air harvesting.

A surface area of the material can be maximized to further enhance the utilization of the moisture deficit in the ambient air to dry the material. For example, the material can be formed in specific shapes and provided with a surface texture to maximize the surface area of the material that is in contact with the ambient air. In addition, the material may be dried into a porous, granular material. The porous nature of the material is considered to significantly enhance the surface area available for drying. The material being dried can be efficiently prepared and/or configured to the desired shapes and surface textures through the utilization of a handling tool, such as a mixer. For example, the handling tool can be used to initially prepare and configure the material for drying and used throughout the drying process to further configure and manipulate the material to facilitate achieving and maintaining a maximum drying rate throughout the drying process. This is different from known drying systems that use two or more handling tools such as a mixier, an extruder, and conveyors, for example to prepare and/or configure the material for drying and can require additional equipment and handling tools to handle the material while being dried. Accordingly, the material drying system of the present disclosure provides the advantage of the handling tool with multifunctionality that provides the advantage of simplicity, minimized cost, and maximized operational efficiency.

The material being dried begins the drying process in a generally liquid/semi solid state through to a dry solid state and having an intermediate state where the material can be in a sticky phase or state. This sludge material in its raw form does not have handling properties that lend itself to surface area enhancement. For example, it is liquid enough that if formed into rows it will slump back into a generally flat surface with less surface area. Achieving a porous nature is not possible with the raw material alone. Methods exist to enhance the surface area of a liquid material, such as using plastic biofilter media or honeycomb sheets like those used within cooling towers. However, the residual solids would remain a challenge and the cost of the support structure adds to the overall cost of the device. Methods such as mixing wet material with dry material and extruding into a belt exist, however they are operationally complex. Clearly, there is a need for simple methods to provide an enhanced surface area of this material.

In order to achieve a desired state of the material, back-mixing of the material in a dry state into the material that is in a liquid/semi solid state and/or the sticky state may be employed utilizing the handling tool in order to achieve the desired handling properties of the material. The material can then be prepared and/or configured wherein handling properties are such that the material is substantially self-supporting and can self-maintain the desired shapes, surface textures, and porosities that maximize the utilization of the moisture deficit in the ambient air to dry the material. The material being configured to be substantially self-supporting and self-maintain the desired shapes, surface textures, and porosities, is distinct from known methods such as drying upon a belt, or drying in a thin layer upon concrete wherein the required surface area of the support structure for the material is relatively large as compared to the invention of the present disclosure. Furthermore, with respect to the invention of the present disclosure, the surface area of the material is many times greater than that of the support structure enabling a larger volume of material to be dried. The practice of back-mixing dry material with wet material is known within solar sludge dryers, and this practice would achieve a porous and relatively air permeable surface. Performing this activity within a device that is energy limited like a solar sludge dryer would have relatively little performance benefit, however. In this invention, as we use a larger energy source (the relative humidity deficit of ambient air) which is capable of achieving higher evaporation rates and therefore is novel.

Additionally, the drying system of the present disclosure can be provided with an air-permeable support structure made of a different material than the material being dried, wherein the ambient air can flow through the support structure and the material disposed thereon to expose even more surface area of the material to the ambient air to take advantage of the moisture deficit in the ambient air to dry the material. The use of the air permeable support structure can further increase the total volume of material that can be dried on the material support structure and/or the footprint area of the material drying system.

Material drying system of the present disclosure provides for an improved system and process for drying materials, such as sludge, for example, as compared to other known state-of-the-art drying systems and processes. In particular, the material drying system of the present disclosure can achieve a higher areal drying rate than existing low-energy methods. Additionally, the material drying system of the present disclosure utilizes a structure that is less expensive to construct to achieve at least the same quantity of evaporation and volume of dried material as other known state-of-the-art drying systems and processes. For example, insulation is not required, less construction materials and structure are required, and less land area is required for the material drying system of the present disclosure. Furthermore, the material drying system of the present disclosure consumes less energy (electricity, etc.) by utilizing the moisture deficit in the ambient air and, when available, the prevailing atmospheric wind, to dry the material.

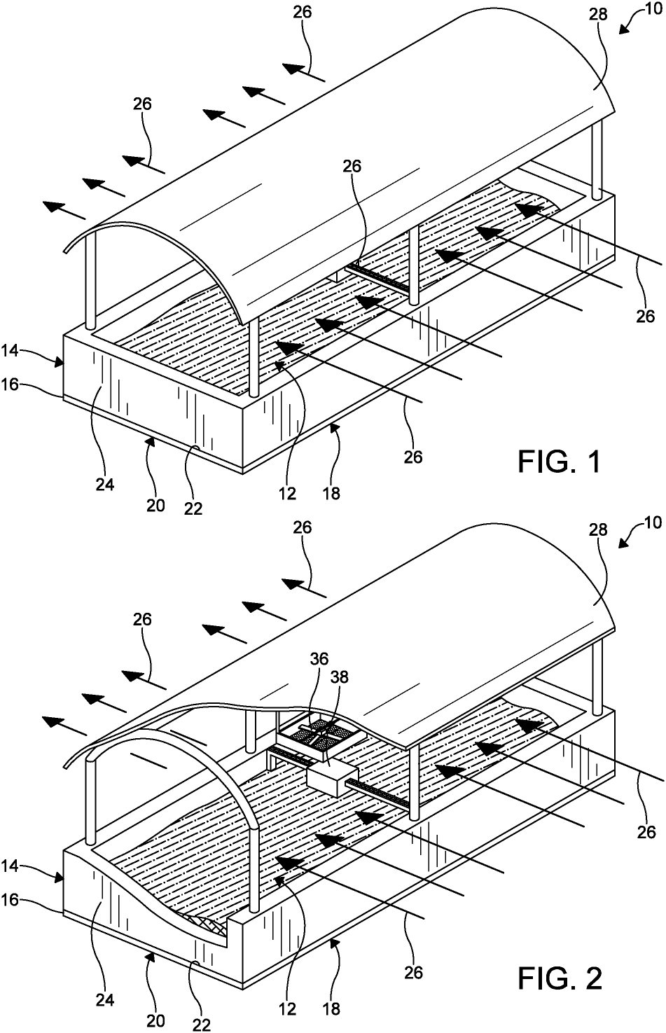

Generally, as shown in FIGS. 1-3, a material drying system 10 for drying a material 12 can include a drying bed 14. The drying bed 14 includes a base 16 having a major axis 18, a minor axis 20, and a peripheral edge 22. A wall 24 is disposed adjacent to the peripheral edge 22 of the base 16, wherein the base 16 and the wall 24 of the drying bed 14 are configured to retain the material 12 within the material drying system 10 during the drying process. The drying bed 14 can be any bed capable of holding and maintaining the material 12 in place during the drying process. Preferably, the drying bed 14 can have a generally rectangular shape having a long side (the major axis 18) and a short side (the minor axis 20) as shown in FIGS. 1-3. It should be understood that the drying bed can have other shapes without departing from the spirit of the present disclosure, such as an oval or an ellipse, for example. The drying bed 14 can be any bed capable of holding and maintaining the material 12 in place during the drying process. A non-limiting example of such a drying bed 14 can be a shallow concrete basin, examples of which are well known to those of skill in the art. Other materials can also be used without departing from the spirit of the present disclosure.

The material drying system 10 can be positioned to place the major axis 18 of the base 16 of the drying bed 14 perpendicular to a prevailing atmospheric wind 26 for the location and/or the site for the material drying system 10. Orienting the major axis 18 of the base 16 of the drying bed 14 perpendicular to the prevailing atmospheric wind 26 maximizes the utilization of the ambient air and the difference in moisture content between the ambient air and the material 12 to dry the material 12. It should be understood that the material drying system 10 can be oriented in other positions relative to the prevailing atmospheric wind 26 without departing from the spirit of the present disclosure.

The wall 24 for use in the material drying system 10 can be integrated as part of the drying bed 14. Alternatively, the wall 24 can be a short wall that works in conjunction with the drying bed 14 to maintain the material 12 in place during the drying process. The wall is optional and exists to provide additional bulk storage of material while drying and may be as high or low as necessary to achieve this outcome. For example, as shown in FIG. 4, in certain embodiments the wall may not be provided and the drying bed 14 includes only the base 16. The wall 24 can be formed of any material known to those of skill in the art. The wall 24 can also be a tall wall without departing from the spirit of the invention. The wall 24 must not or, at most, minimally, impede a flow of air in the material drying system 10 from flowing across the of the material 12 held in the drying bed 14. When the wall 24 is tall, openings, windows or other adequate means for ventilation can be included in the wall 24 to enable wind flow through the material drying system 10.

A cover 28 can be provided that covers the drying bed 14 of the material drying system 10. The cover 28 is configured to permit a flow of the ambient air through the material drying system 10 and protect the material drying system 10 from unwanted materials, such as rain, dew, debris, and other materials, for example, from falling into the drying bed 14 and contacting the material 12 held therein. The cover 28 can be formed from any material or structure capable of protecting the material drying system 10 from the unwanted materials. A non-limiting example of a cover 28 can be a hoop greenhouse cover. FIG. 4 illustrates another embodiment of the cover 28, wherein the cover 28 can be a cover disposed adjacent to the material 12 to form an air flow path between an upper surface of the material and the cover 28 to facilitate the flow of the ambient air across the drying bed 14 and the material 12 held thereon. The cover 28 can be raised or lowered to provide a desired distance between the upper surface of the material 12 and the cover 28. In one non-limiting example, the distance between the upper surface of the material 12 and the cover 28 is about six inches (6″) or less. Other examples of the cover 28 can be used without departing from the spirit of the present disclosure. Preferably, the material for the cover 28 is one that is transparent, to allow sunlight to reach the material and assist the drying process. In addition, preferably the material for the cover 28 is one that militates against an accumulation of moisture vapor and minimizes a humidity within the material drying system 10 in order to utilize the difference between the moisture content of the material 12 and the prevailing atmospheric wind 26.

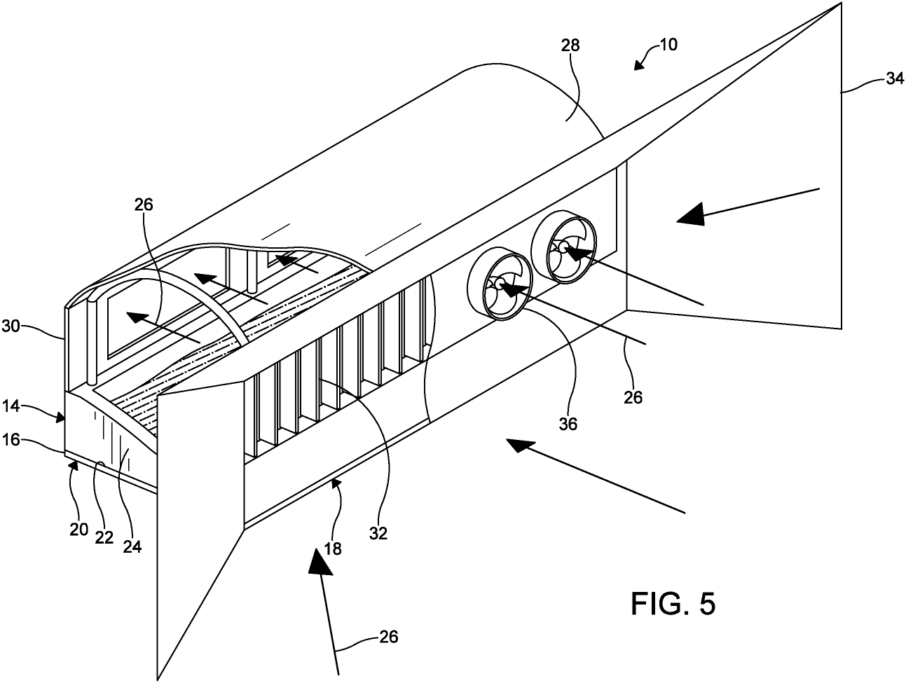

As shown in FIG. 5, the cover 28 can also include a sidewall 30. The sidewall 30 is configured to protect the material drying system 10 from unwanted materials, such as rain, dew, debris, and other materials, for example, from blowing and/or falling into the drying bed 14 and contacting the material 12 held therein. A length of the sidewall 30 can be selected to provide a desired amount of protection from unwanted materials and may be adjusted to account for changes in weather and other atmospheric conditions. It should be understood that the sidewall 30 can allow for adequate ventilation and not prevent, or significantly reduce, the flow of the ambient air into or through in the material drying system 10. Accordingly, the sidewall 30 may include windows and/or apertures to facilitate the flow of the ambient air into and through the material drying system 10. Furthermore, the sidewall 30 can be employed to facilitate a control of the flow of the ambient air into and out of the material drying system 10 by adjusting a portion of the side of the material drying system 10 that is covered by the sidewall 30 and/or by adjusting the size, number, and status (open or closed) of any windows or apertures formed in the sidewall 30. The sidewall may also be a curtain, that is able to open and close based on weather conditions to provide the optimum drying conditions inside the drying system.

With renewed reference to FIGS. 1-3, the material drying system 10 can also include a handling tool 38 for mixing the material 12 held in the drying bed 14. It should be understood that the handling tool 38 can be employed to till the material 12 itself, form the material 12 into a desired shape or configuration, and to mix the material 12 with an additional portion of the material 12 that is added to the drying bed 14. The additional portion of the material 12 can be substantially similar in solid content as compared to the material 12 or different in solid content from the material 12. For example, additional portion of the material 12 can have a higher solid content (dryer) than the material 12, and the two materials mixed together to facilitate the drying of the mixed materials. Alternatively, the additional portion of the material 12 can have a lower solid content (wetter) than the material 12, and the two materials mixed together to facilitate the drying of the mixed materials. Furthermore, a relatively dry layer or portion of the material 12 can be removed from the drying bed 14 and additional portion of the material 12 that has a lower solid content (wetter) than the remailing portion of the material 12 can be added to and mixed with the material 12 utilizing the handling tool 38. Furthermore, the handling tool 38 can be configured to mix at a selected depth into the material 12. For example, the handling tool 38 can be set to mix the material 12 adjacent the top surface of the material 12 while leaving the material 12 adjacent the base 16 of the drying bed 14 substantially undisturbed. The handling tool 38 can be set to mix at a range from substantially full depth of the material 12 to the top surface of the material 12. The handling tool 38 can also be configured to be in fluid communication with a source of the material 12, wherein the source of the material 12 is remote from the material drying system 10 and an additional amount of the material 12 can be added to the drying bed 14 utilizing the handling tool 38. The handling tool 38 can also be moveable with respect to the drying bed 14, wherein the mixer can move laterally and longitudinally with respect to the drying bed 14 and reach substantially all the material 12 held in the drying bed 14.

As shown in FIGS. 2-5, The material drying system 10 can also include at least one of, an air flow directing device 32, an air flow collection device 34, and a fan 36. Each of the air flow directing device 32, the air flow collection device 34, and the fan 36 can be disposed adjacent at least one of the peripheral edge 22 and the wall of the base 16 of the drying bed 14 and/or the cover 28 and the sidewall 30 of the cover 28. It should be understood the material drying system 10 can also include the air flow directing device 32, the air flow collection device 34, and the fan 36 disposed in an interior of the material drying system 10 to assist in directing and moving the ambient air within the interior. The air flow directing device 32 can include air handling components such as air louvers, veins, deflectors, and ducts, for example, that are configured to facilitate the flow of the prevailing atmospheric wind 26 in a desired direction with respect to the drying bed 14. The air flow collection device 34 can include wind catchers and sails that can be used to both capture and direct the prevailing atmospheric wind 26. Other types of the air flow directing device 32 and the air flow collection device 34 are well known to those of skill in the art can be used without departing from the spirit of the present disclosure. The fan 36 can be configured to increase a flow of the ambient air in contact with the material 12 in the material drying system 10, or the contact of air with the material being dried. It should be understood that the fan 36 can be positioned to blow air into or draw air from the material drying system 10. In certain embodiments, the fan 36 can be disposed in a shroud and/or be a box type fan to facilitate the ability to direct the air flow into and from the fan 36. Alternatively, the fan 36 can be open and/or a ceiling type fan, wherein the air flow into and from the fan 36 can include at least a portion of the flow of air in a radial direction with respect to a center axis of the fan 36 to provide the desired circulation of air within and through the material drying system as well as across the surface of the material 12. It should also be understood that the air flow directing device 32, the air flow collection device 34, and the fan 36 can be used individually or in any combination thereof to maximize the flow of the prevailing atmospheric wind 26 through the material drying system 10. The air flow directing device 32, the air flow collection device 34, and the fan 36 are all designed to function individually and in cooperation to maximize the amount of airflow across the surface of the material 12 being dried in the material drying system 10.

It should be understood that the flow of air moving horizontally (parallel to the surface of the material 12) is at a speed designed to ensure sufficient refreshment of the air in contact with the surface of the material 12. This speed can be a function of the partial pressure of water within the prevailing atmospheric wind 26 and the evaporation rate achieved upon the surface of the material 12. Accordingly, the air flow directing device 32, the air flow collection device 34, and the fan 36 can be employed to facilitate a control of the speed of the of the airflow to help ensure sufficient refreshment of the air in contact with the surface of the material 12 while minimizing excessive air flow speed that can blow the material 12 from the drying bed 14 or reduce the efficiency of the material drying system 10.

As shown in FIGS. 2-4, the fan 36 can be disposed within an interior of the material drying system 10. The fan 36 is utilized to facilitate the flow of the ambient air through the material drying system 10 and increase the flow to be greater than that provided by the prevailing atmospheric wind 26. During time periods when the prevailing atmospheric wind 26 is less than desired, the fan 36 can be utilized to maintain a desired flow of ambient air through the material drying system 10. The fan 36 can be positioned adjacent the cover 28 and oriented to blow the ambient air passing through the material drying system toward the material 12. As a non-limiting example, the fan 36 can be oriented to blow the air in a substantially vertical direction, substantially perpendicular to the surface of the material 12. The fan 36 can also be oriented to blow or draw the ambient air across the surface of the material through the material drying system 10, wherein the fan 36 directs the air flow at a selected angle from being perpendicular to the surface of the material 12 to being parallel to the surface of the material 12. As a non-limiting example and shown in FIG. 4, the fan 36 can be positioned adjacent the peripheral edge 22 of the base 16 and or adjacent the cover 28 and blow or draw the ambient air across the surface of the material 12. It should be understood that more than one fan 36 may be employed to facilitate the movement of the ambient air in and/or through the material drying system 10.

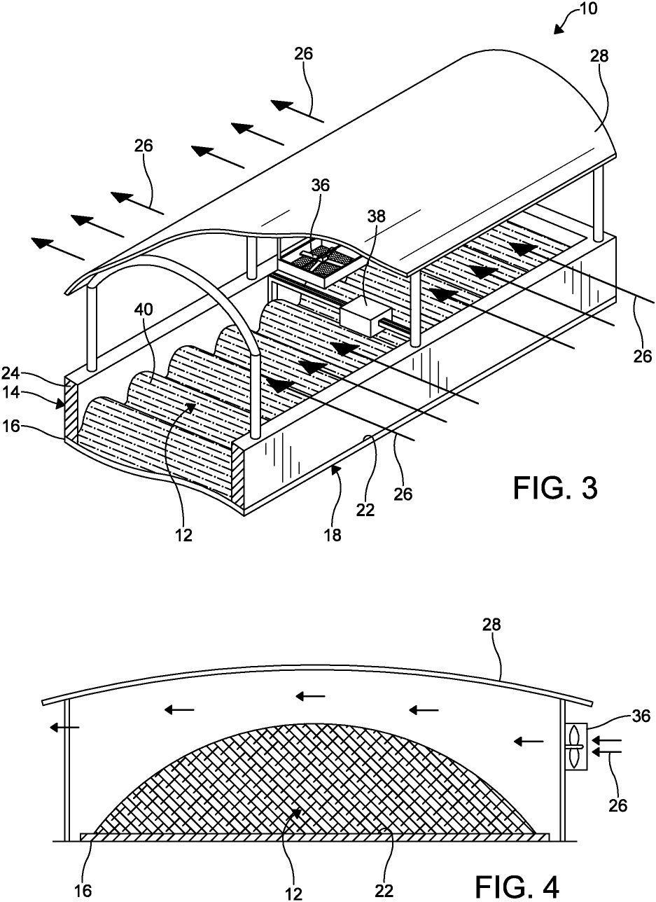

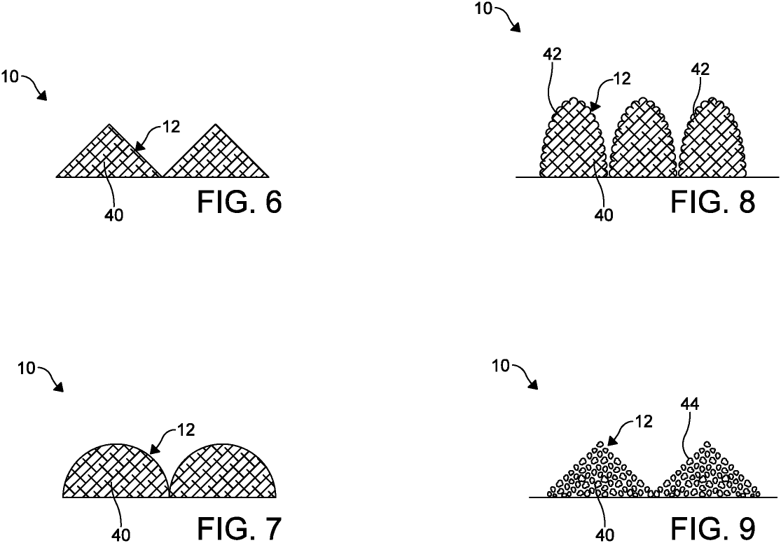

The material 12 that can be dried in the material drying system 10 can be any material in need of this form of drying, examples of which are well known to those of skill in the art. A non-limiting example can be animal waste. The material 12 can be held as a substantially wet and flowable material generally pooled on the base 16 and/or filling the drying bed 14. The material 12 can be arranged generally horizontally upon the base 16 of the drying bed 14 in a relatively thin, flat layer having a thickness in the range of about 1 inch to 24 inches, or thicker, with airflow moving generally horizontally (parallel) to the surface of the material 12 at a speed designed to ensure sufficient refreshment of the air in contact with the surface of the material 12. Alternatively, and as shown in FIGS. 3 and 6-9, once in the drying bed 14, the material 12 can be arranged in a row 40, the row 40 is configured to enhance the drying process by creating an increased surface area of the material 12. In a preferred embodiment the row 40 of the material 12 is oriented generally parallel to the direction of the air flow through the material drying system 10. In a non-limiting example, the row 40 is oriented parallel to the minor axis 20 of the base 16 of the drying bed 14 which positions the row 40 generally parallel to the prevailing atmospheric wind 26. As shown in FIGS. 6-7, the row 40 can be formed to have a cross-sectional shape that enhances the drying process of the material 12. For example, the cross-sectional shape can be a generally triangular shape as shown in FIG. 6 or a semi-circle shape as shown in FIG. 7. As compared to a substantially flat surface, the row 40 having the triangular cross-sectional shape has about a 40% increase in surface area and the row 40 having the semi-circle cross-sectional shape has about a 57% increase in surface area. The increased surface area provided by the selected cross-sectional shape of the row 40 facilitates the drying of the material 12. One of skill in the art can utilize the present disclosure to optimize a specific width and height of the row of the material 12. The cross-sectional shapes and configurations of the row 40 show some non-limiting examples of potential shapes and configuration for the material 12. Alternative configurations, as can be determined by one of skill in the art based on the present disclosure can also be used without departing from the spirit of the present disclosure. The configuration of the material 12 can be modified and optimized based on the known or understood characteristics of the material 12 to be dried. One of skill in the art can utilize the present disclosure to optimize the specific configuration of the material 12.

As shown in FIG. 8, an undulating and/or a textured surface 42 can be provided for the surface of the material 12 when placed in the drying bed 14 for drying. The textured surface 42 maximizes the surface area of the material 12, in order to increase the drying rate. It has been found that the textured surface 42 applied to the substantially triangular cross-sectional shape can provide about a 100% increase in surface area (twice the surface area) as compared to an un-textured substantially flat surface. The textured surface 42 can be imparted to the surface of the row 40 by manual means or by mechanical means such as employing the handling tool 38, for example, when distributing the material 12 in the drying bed 14 and/or when forming the row 40. The textured surface 42 can also be provided by mixing or preparing the material 12 to be in a substantially granular form, wherein the individual grains and/or particles from the granular form of the material 12 provide for the textured surface 42 to the material 12. The textured surface 42 of the material can also be provided and/or enhanced by adding a second material and/or an additional portion of the material 12 to the material 12 held in the drying bed 14, wherein the second material and/or the additional portion of the material 12 provides grains and particles to facilitate the forming the undulating and textured surface to the row 40. It should be understood that the second material and/or the additional portion of the material 12 can be applied to and/or sprinkled on the surface of the material 12 and/or mixed in the material 12 to facilitate forming the textured surface 42. The surface treatment can include, but is not limited to, systems where a size of at least a portion of the grains and particles of the material 12 and/or the second material employed to form the textured surface 42 is made smaller than about a half of an inch (½″).

With reference to FIG. 9, the material 12 can be configured to be in a generally porous configuration 44 at least in a portion of the material adjacent to the surface of the material 12. The generally porous configuration 44 can be achieved by forming granular particles in the material 12 by mixing, utilizing the handling tool 38, or other suitable processes or adding granular particles as the second material to the material 12. The granular particles provide a porous nature to the material 12 by creating interstitial spaces between adjacent granular particles. The rate of the drying of the material 12 is enhanced by the generally porous configuration 44 as the atmospheric air can pass through at least a portion of the material 12 in addition to passing over the surface of the material 12. The generally porous configuration 44 can facilitate the drying through a depth of material 12 rather than simply at the surface of the material 12. It has been found that the generally porous configuration 44 of the material 12 combined with the substantially triangular cross-sectional shape of the row 40 can provide greater than a 100% increase in surface area as compared to a non-porous flat surface. The generally porous configuration 44 can be achieved by, but is not limited to, providing granular particles smaller than about one-half of an inch (½″) in order to maximize the drying rate relative to larger particles and reduce the effect of declining-rate drying upon the process. Alternatively, the particle size of the granular particles may be managed in a way to maximize the absolute size of the pore space between particles. This would have the effect of increasing the depth of air penetration into the material 12. The overall surface area available for drying being a function of the surface area of the particles and the depth of air exchange occurring, increasing the depth of air exchange therefor increases the effective surface area available for drying. This may be particularly the case in examples whereby the material 12 that is re-added to the dried material 12 is more wet than the dried material 12. This wet material 12 would be added in a way to minimize blocking of the pore spaces between particles, larger pore spaces would allow for a more practical process where the wet material 12 is less likely to block the pore spaces relative to if the pore spaces were smaller.

The textured surface 42 or generally porous configuration 44 shown in FIGS. 8-9 may also be achieved by operating the handling tool 38 preferentially upon the surface of the material while it is drying. In this case, the added material 12 loaded into the material drying system 10 does not have handling properties conducive to surface area enhancement. As the surface of the material 12 dries, it begins to have handling properties that are conducive to surface area enhancement. By managing the depth of the mixing process to focus it only on this partially dry surface, the time taken to achieve properties conducive to enhanced surface area may be reduced, with a consequential improvement in drying performance.

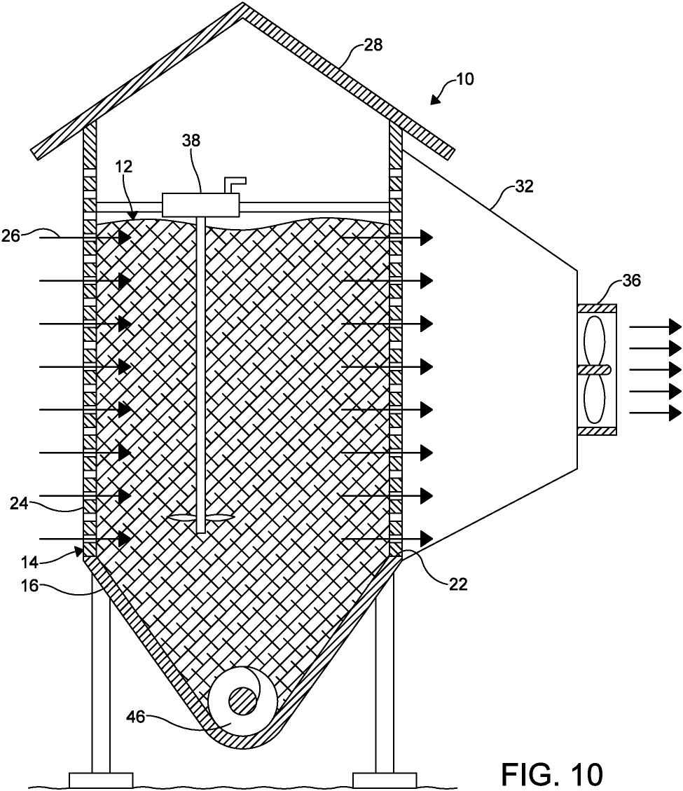

In another embodiment, shown in FIG. 10, the wall 24 of the drying bed 14 for the material drying system 10 can be air permeable and configured to support the material 12 disposed in the drying bed 14. The wall 24 allows the prevailing atmospheric wind 26 to cause the ambient air to pass through the wall 24 and through the material 12 as well as across the surface of the material 12. An auger 46 can be provided adjacent the base 16 to facilitate an unloading of the material 12 from the drying bed 14 and/or a loading of the material 12 into the drying bed 14. The cover 28 is configured to cover an upper end of the drying bed 14 and militate against unwanted materials, such as rain, dew, debris, and other materials, for example, from falling into the drying bed 14 and contacting the material 12 held therein. The air flow deflecting device 32, the air flow collection device 34, and the fan 36 can be provided adjacent to the wall 24 to facilitate the flow of the atmospheric air through and across the material 12. In the embodiment shown in FIG. 10, the air flow directing device 32 is a baffle having the fan 36 disposed on an exhaust side of the baffle, wherein the fan 36 facilitates drawing the atmospheric air through the wall 24 and through and across the material 12. It should be understood that the air flow directing device 32 and the fan 36 can be configured to push or blow the ambient air through the wall 24 and through and across the material 12. It should also be understood that the embodiment shown if FIG. 10 can also include the air flow collection device 34 (not shown) disposed adjacent to the wall 24 of the drying bed 14 to facilitate the capture and flow of the prevailing atmospheric wind 26 through the wall 24 and through and across the material 12. The embodiment shown in FIG. 10 also can include the handling tool 38 wherein the handling tool 38 is configured to mix the material 12 within the drying bed 14 at selected depths and locations within the drying bed 14, and also can be configured to supply an additional quantity of the material 12 to the drying bed 14.

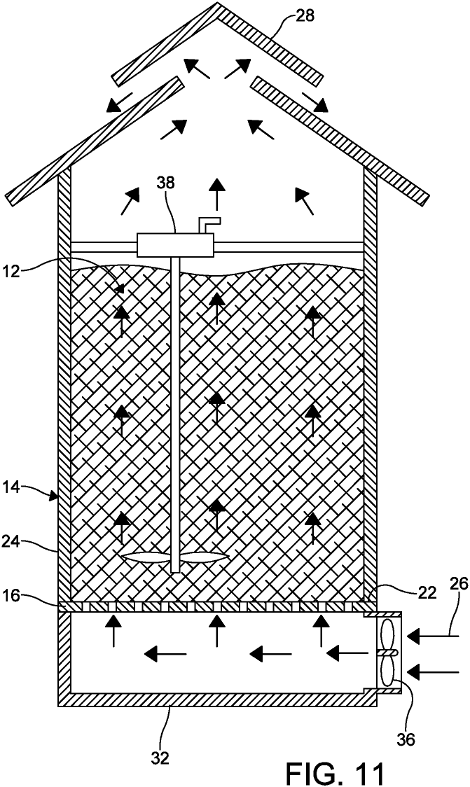

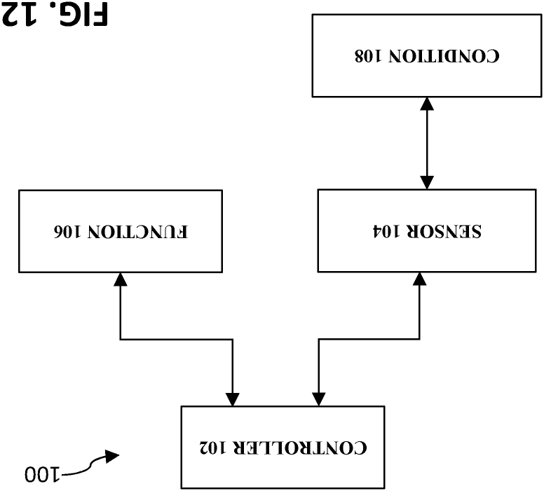

In another embodiment, shown in FIG. 11, the base 16 of the drying bed 14 for the material drying system 10 can be air permeable. The base 16 can be formed of a material having through holes formed therein, a filter material, a fabric, layers of differing materials (such as sand, gravel, etc.), and combinations thereof. The base 16 is configured to be air permeable while still supporting the weight of the material 12 contained in the drying bed 14 disposed on a top surface of the base 16. The base 16 allows the atmospheric air to be captured and/or directed from a bottom surface of the base 16 and exhausted from the top surface of the base, through the material 12 held in the drying bed 14. The cover 28 is configured to cover an upper end of the drying bed 14 and militate against unwanted materials, such as rain, dew, debris, and other materials, for example, from falling into the drying bed 14 and contacting the material 12 held therein. The cover 28 is also configured to allow for the atmospheric air that flowed through the material 12 to exhaust to the atmosphere at or adjacent to the upper end of the drying bed 14. The air flow deflecting device 32, the air flow collection device 34, and the fan 36 may be provided adjacent to the base 16 or the wall 24 of the drying bed 14 and configured to facilitate the flow of the atmospheric air through the base 16 and the material 12. In the embodiment shown in FIG. 11, the air flow directing device 32 is a plenum or other suitable duct work. The fan 36 is disposed on an inlet side or within the plenum, wherein the fan 36 facilitates the flow of the prevailing atmospheric wind 26 through the through the plenum, the base 16, and the material 12. It should be understood that the embodiment shown if FIG. 11 can also include the air flow collection device 34 (not shown) disposed adjacent to the base 16 of the drying bed 14 and/or the plenum and the fan 36 to facilitate the capture and the flow of the atmospheric air through the base 16 and the material 12. The embodiment shown in FIG. 11 also can include the handling tool 38 wherein the handling tool 38 is configured to mix the material 12 within the drying bed 14 at selected depths and locations within the drying bed 14, and also can be configured to supply an additional quantity of the material 12 to the drying bed 14.

The embodiments of the material drying system 10 shown in FIGS. 10-11 can be used to enhance surface-area relative to site footprint, in comparison to a conventional drying system. This enhanced surface-area can increase the capacity of an enhanced drying rate in an inexpensive structure, with substantially reduced cost. However, the material 12 held in the embodiments shown in FIGS. 10-11 needs to be prepared such that it can be self-supporting and generally porous to facilitate the flow the prevailing atmospheric wind 26 through the material 12. The material 12 can be prepared to be at the required liquid to solids ratio by first drying a wetter material until it dries to the required liquid to solids ratio and then transferring the material 12 to the material drying system 10 illustrated in either FIG. 10 or FIG. 11 for final drying. Alternatively, a process of back-mixing of final dry material 12 with wet material 12can be used to provide appropriate handling properties so the material 12 can be self-supporting and have an acceptable liquid to solids ratio for use in the material drying system 10 illustrated in either FIG. 10 or FIG. 11. Additionally, other techniques known for use in handling and preparing material with the properties of sludge can also be used to achieve acceptable liquid to solids ratio in the material 12.

As shown in FIG. 12, a control system 100 can be provided for the material drying system 10 to selectively control desired functional aspects of the material drying system 10. The control system 100 includes a controller 102 and a sensor 104. The controller 102 is in communication with the sensor 104 and a function 106 of the material drying system 10, wherein the function 106 is at least one of the handling tool 38, the air flow directing device 32, the air flow collection device 34, and the fan 36. Furthermore, when the cover 28 and/or the sidewall 30 is configured to be adjustable, the function 106 can include an adjustment device configured to effectively adjust the cover 28 and/or the sidewall 30 of the material drying system 10. The sensor 104 is in communication with the controller and configured to sense a condition 108 associated with at least one of the material 12, the ambient air, and other whether related atmospheric conditions. The sensor 104 can communicate the condition 108 to the controller 102, wherein the controller 102 receives the condition 108 and can control the function 106 to achieve and/or maintain desired conditions within the interior of the material drying system 10. The control system 100 facilitates achieving and maintaining maximized drying rates of the material 12 within the material drying system 10. It should be understood that the control system 100 can be employed to monitor the speed, moisture content, and direction of the ambient air and/or prevailing atmospheric wind 26 and adjust at least one of the air flow directing device 32, the air flow collection device 34, the fan 36, and the position of the cover 28 and/or sidewall 30 to achieve and/or maintain desired conditions within the interior of the material drying system 10. As a non-limiting example, the control system 100 can be employed to monitor the moisture content of the material 12 in the drying bed 14 and activate the handling tool 38 in a desired manner, including but not limited to the functions of, moving and positioning of the handling tool 38, adding the material 12 to the drying bed 14, initiating and stopping the mixing of the material 12, setting the depth of the mixing of the material 12, forming the material 12 into a desired shape or configuration, texturizing the surface of the material 12, forming the material 12 into granular pieces, for example. The control system 100 can be used by an operator of the material drying system 10 to manually control the function 106 of the material drying system 10. Furthermore, the control system 100 can include automated capabilities, wherein the sensor 104 communicates the condition 198 and the controller 102, and without input from a human operator, controls the function 106 of the material drying system 10 to achieve and/or maintain optimized conditions for drying the material 12 in the material drying system 10.

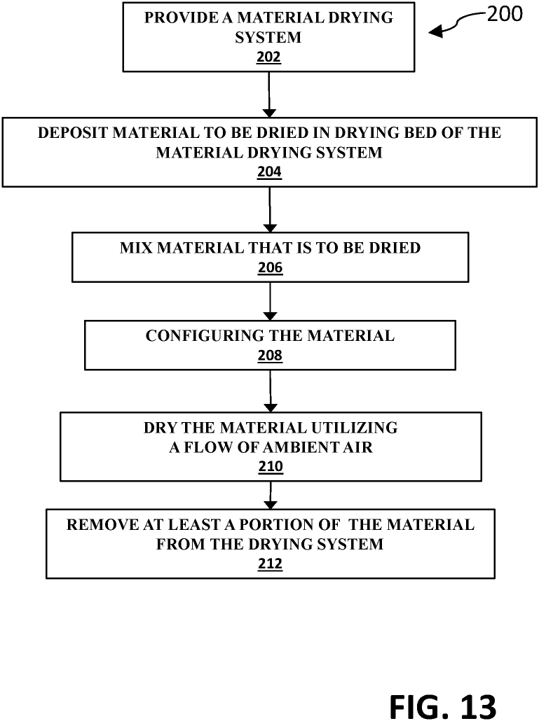

With reference to FIG. 13, a method 200 of using the material drying system 10 is shown. The method 200 having a step 202 of providing the material drying system 10. In a step 204, the material 12 that is to be dried is deposited in the drying bed 14. In a step 206, the material 12 is mixed to facilitate a desired configuration and/or a consistency of the material. A second material and/or an additional portion of the material 12 can be added to and mixed with the material 12 in the step 206. The added material can have a solids content different from the material 12 initially deposited in the drying bed 14, wherein the added material is utilized to achieve a desired solids content in the mixed material formed from the material 12 and the second material. The process steps for mixing the material can be utilized when desired in the drying process. For example, the mixing process can be utilized at any time while the material 12 is in the drying bed 14 and/or prior to placing the material 12 into the drying bed 14. The material 12 can be configured in a step 208, wherein the configuration maximizes a surface area of the material 12 and/or shapes the material 12 held on the base 16 of the drying bed 14 and/or withing the drying bed 14. In a step 210, the material 12 is dried to a selected target percentage of solid content, wherein the ambient air is utilized to dry the material 12. It should be understood that the step 208 of configuring the material can be completed one or more times in the method 200. For example, the step 208 can be completed at one or more points of time while the material 12 is drying in step 210. In a step 212, at least a portion of the material 12 held on the base 16 of the drying bed 14 and/or withing the drying bed 14 is removed from the material drying system 10.

The material drying system 10 of the present disclosure can take advantage of the moisture deficit in ambient air which can provide significant advantages for drying the material 12 relative to conventional drying. The material drying system 10 of the present disclosure can enable substantially higher area drying rates using ambient air drying than with other conventional solar sludge drying systems. This yields consequently smaller site footprints for the material drying system 10 and relatively low cost of construction, as compared to conventional drying systems. Accordingly, the material drying system 10 is a relatively low capital cost system to construct that utilizes the moisture deficit of ambient air and prevailing atmospheric winds to also provide a relatively low operational cost as compared to conventional drying systems.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments can be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method of drying a material, comprising performing at least one of:
depositing a material to be dried in a material drying system;
mixing the material within the material drying system to a self-supporting state;
configuring the material to maximize a surface area of the material in contact with an ambient air;
drying at least a portion of the material contained in the material drying system to a selected target percentage of solids content, wherein a relative humidity deficit of the ambient air is utilized to dry the material; and
removing at least a portion of the dried material from the material drying system.

2. The method of drying a material of claim 1, further comprising the step of forming a textured top surface of the material to maximize a surface area of the material.

3. The method of drying a material of claim 1, further comprising the step of forming the material into a row, the row having one of a generally triangular a cross-section shape and a semi-circle cross-section shape.

4. The method of drying a material of claim 1, further comprising the step of configuring at least a portion of the material to have a granular form to provide a porous nature to the material at least adjacent a top surface of the material.

5. A material drying system for use in performing the method of claim 1, the material drying system comprising:
a drying bed for holding a material to be dried, the drying bed having a base including a peripheral edge,
a wall disposed adjacent the peripheral edge;
a cover placed over the drying bed and configured to substantially prevent a second material from falling on the material held in the drying bed and permit a flow of the ambient air through the material drying system;
a handling tool disposed adjacent the drying bed, the handling tool configured to mix the material and maximize a surface area of the material that is in contact with the ambient air flowing through the material drying system; and
a fan disposed adjacent at least one of the drying bed and the cover, the fan configured to facilitate the flow of the ambient air through the material drying system.

6. The material drying system of claim 5, wherein the base of the drying bed is air permeable and the flow of the ambient air is directed to flow through the base and the material held in the drying bed.

7. The material drying system of claim 5, wherein the base includes a peripheral edge and a wall disposed adjacent the peripheral edge, the wall being air permeable and the flow of the ambient air is directed to flow through the wall and at least one of across and through the material held in the drying bed.

8. The material drying system of claim 5, wherein the cover for the drying bed includes a sidewall, the sidewall configured to facilitate the flow of the ambient air into the material drying system adjacent to the material.

9. A method of drying a material, comprising:
providing a material drying system including
a drying bed for holding a material to be dried, the drying bed having a base;
a cover placed over the drying bed and configured to substantially prevent a second material from falling on the material held in the drying bed and permit a flow of an ambient air through the material drying system;
a handling tool disposed adjacent the drying bed, the handling tool configured to mix the material and maximize a surface area of the material that is in contact with the ambient air flowing through the material drying system; and
a fan disposed adjacent at least one of the drying bed and the cover, the fan configured to facilitate the flow of the ambient air through the material drying system; and
performing at least one of:
depositing a material to be dried in a material drying system;
mixing the material within the material drying system to a self-supporting state;
configuring the material to maximize a surface area of the material in contact with the ambient air;
drying at least a portion of the material contained in the material drying system to a selected target percentage of solids content, wherein a relative humidity deficit of the ambient air is utilized to dry the material; and
removing at least a portion of the dried material from the material drying system.

10. The method of drying a material of claim 9, further comprising the step of forming a textured top surface of the material to maximize a surface area of the material.

11. The method of drying a material of claim 9, further comprising the step of forming the material into a row, the row having one of a generally triangular a cross-section shape and a semi-circle cross-section shape.

12. The method of drying a material of claim 9, further comprising the step of configuring at least a portion of the material to have a granular form to provide a porous nature to the material at least adjacent a top surface of the material.

13. A material drying system comprising:
a drying bed for holding a material to be dried, the drying bed having a base;
a cover placed over the drying bed and configured to substantially prevent a second material from falling on the material held in the drying bed and permit a flow of an ambient air through the material drying system;
a handling tool disposed adjacent the drying bed, the handling tool configured to mix the material and maximize a surface area of the material that is in contact with the ambient air flowing through the material drying system; and
a fan disposed adjacent at least one of the drying bed and the cover, the fan configured to facilitate the flow of the ambient air through the material drying system.

14. The material drying system of claim 13, wherein the material is arranged in a row, the row having one of a generally triangular cross-sectional shape and a semi-circle cross-sectional shape.

15. The material drying system of claim 13, wherein the material includes a textured surface to maximize a surface area of the material.

16. The material drying system of claim 13, wherein at least a portion of the material adjacent a top surface of the material held in the drying bed is in a granular form and porous to maximize a surface area of the material in contact with the ambient air flowing through the material drying system.

17. The material drying system of claim 13, wherein at least a portion of the material is self-supporting to facilitate maintaining the material in a desired shape.

18. The material drying system of claim 13, wherein the base includes a peripheral edge and a wall disposed adjacent the peripheral edge, the wall being air permeable and the flow of the ambient air is directed to flow through the wall and at least one of across and through the material held in the drying bed.

19. The material drying system of claim 13, wherein the base of the drying bed is air permeable and the flow of the ambient air is directed to flow through the base and the material held in the drying bed.

20. The material drying system of claim 13, further comprising a control system, the control system including a controller and a sensor, the controller in communication with the sensor and at least one of the handling tool and the fan, the sensor in communication with the controller and configured to sense a condition of at least one of the ambient air and the material and communicate the condition to the controller, wherein the controller receives the condition and controls a function of at least one of the handling tool and the fan in a response to the condition in order to facilitate the drying of the material.
